(19) United States
(12) Patent Application Publication
(10) Pub. No.: US 2007/0118471 A1
(43) Pub. Date: May 24, 2007

(54) Contract system

(76) Inventor: Edward Fredkin, Brookline, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/582,822

(22) Filed: Oct. 18, 2006

Related U.S. Application Data
(60) Provisional application No. 60/727,710, filed on Oct. 18, 2005.

(51) Int. Cl. G06Q 40/00

(52) U.S. Cl. 705/39

(57) ABSTRACT

A method for efficient contracting comprises receiving a request for a financial transaction having transaction parameters, selecting candidate transactions based on one or more of the transaction parameters and combining the selected candidate transactions to provide a transaction solution. The selecting may comprise calculating one or more figures of merit for the candidate transactions and sorting the candidate transactions based on the figures of merit. The combining may comprise representing the requested transaction as a three-dimensional object, representing the selected candidates as three-dimensional objects and tiling the three-dimensional object representing the requested object with the three-dimensional objects representing the selected candidates. The selecting and the combining may be repeated to provide multiple transaction solutions. The transaction solution may be sent to a party to the requested transaction.

### RELATED APPLICATION

This application claims the benefit of U.S. Provisional Application No. 60/727,710, filed on Oct. 18, 2005. The entire teachings of the above application are incorporated herein by reference.

### BACKGROUND

A large variety of financial transactions exist that include many kinds of possible players such as borrowers and lenders, buyers and sellers or traders and other traders. The costs for conducting financial transactions include interest costs and other costs and overhead. There is a need for improved methods and systems that can provide better terms than are possible using ordinary banking and financial processes. There is also a need for improved efficiency where the cost or benefit of every transaction is better for all the parties to the transaction.

### SUMMARY

In accordance with the present approach, a method for efficient contracting comprises receiving a request for a financial transaction having transaction parameters; selecting candidate transactions based on one or more of the transaction parameters; and combining the selected candidate transactions to provide a transaction solution. The selecting may comprise calculating one or more figures of merit for the candidate transactions and sorting the candidate transactions based on the figures of merit. The combining may comprise representing the requested transaction as a three-dimensional object; representing the selected candidates as three-dimensional objects; and tiling the three-dimensional object representing the requested object with the three-dimensional objects representing the selected candidates. The selecting and the combining may be repeated to provide multiple transaction solutions. The transaction solution may be sent to a party to the requested transaction.

The transaction parameters may include interest rate, amount of principal, time duration of term, start date of requested transaction and end date of requested transaction. The request may be received from a borrower, lender, buyer, seller or trader. The candidate transactions may include multiple lenders, multiple borrowers, multiple sellers and multiple buyers.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 illustrates a contract system.

FIG. 2 illustrates an embodiment of a server for the contract system of FIG. 1.

FIG. 3 illustrates a database for the contract system of FIG. 1.

FIG. 4A illustrates a contract box element.

FIG. 4B illustrates tiling based on box elements.

FIG. 5 illustrates a process for the server of FIG. 2.

### DETAILED DESCRIPTION

A description of example embodiments of the invention follows.

What is now described is a contract system, referred to herein as an algorithmic contract system (ACS), which allows financial transactions to be more efficient. The term “algorithmic” is used herein to refer to the manner of characterizing or expressing aspects of a contract or transaction in mathematical terms, such as interest rates, loan terms and principal amounts. Embodiments of an ACS as defined herein make it possible to arrange for a large variety of financial transactions where, for example, the interest costs of borrowing are decreased while the interest income available from lending are, at the same time, increased. A further consequence is a great reduction in all other costs and overheads. ACS is particularly useful and productive in the area of major financial transactions. We define a few examples of the many kinds of possible players as borrowers and lenders, buyers and sellers or traders and other traders. For example, if a bank lends $100 M (one hundred million dollars) to a corporation, then the bank is the lender and the corporation is the borrower. If a corporation deposits $100 M with a bank, then the corporation is the lender and the bank is the borrower. In general, for most such transactions, the borrower also promises to pay interest to the lender. If one party wishes to trade [symbol] 100 M for US Dollars then both parties may be considered traders. If a bank wishes to purchase insurance to cover possible loss from an existing loan, then the bank is the buyer of that insurance and the insurer is the seller. Transactions can also include purchasing and selling futures on various commodities, insurance of various kinds or hedging on various foreign currencies. These are examples of such transactions and of the parties involved; however, the applications of ACS are in no way limited to just these kinds of transactions or these kinds of parties.

An ACS allows a party seeking to do a financial transaction to effectively conduct the transaction with ACS while the ACS conducts multiple other transactions, of various kinds, to effectively cover its obligations to that party and perhaps to other parties. What is very different about ACS is that it can make use of a very large number of diverse transactions so that all the various single transactions involved are covered on better terms than would be likely to be obtained by ordinary banking processes. In addition, a hallmark of ACS is efficiency where the cost or benefit of each transaction is better for all the parties involved and where many transactions can be decided on and carried out much more quickly and expeditiously than is possible today, even for very large transactions.

Every transaction involves fees to the parties involved. In many cases, one set of parties pays fees and the other set of parties to the same transactions receives fees (interest). For some transactions such as foreign currency exchanges it may be that all parties pay fees. Fees are also paid for insurance and other financial transactions. In addition, the entity providing the ACS service may charge fees for its services.

As a further example we can look at simple lending by a bank. The bank borrows wholesale amounts of money from the Federal Reserve or other sources. It can then lend out retail amounts of money to individuals and businesses as the opportunities arise. Of course, the bank can park its excess funds so as to receive income. With embodiments of ACS, the approach is quite different. ACS does not need to actually obtain finds in advance of when they are needed. Instead, ACS builds a database of information about the desires and intentions of lenders, borrowers and other parties to a transaction so that various particular demands for borrowing can be connected to various other demands for lending in novel ways. The information may be associated with contractual willingness to perform some financial transaction or range of possible transactions. The resulting efficiency of this process allows the parties to obtain better terms with less wasted time while leaving good profit potential for the provider of ACS.

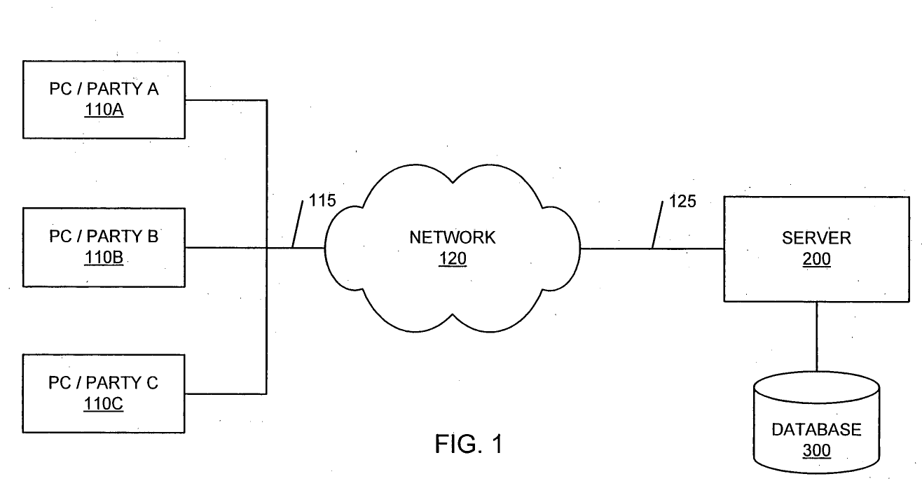

FIG. 1 is a block diagram of an example contract system that illustrates principles of the present approach. The contract system includes personal computers 110A, 110B, 110C, network 120, server 200 and database 300.

The network 110 may comprise wireless, wireline, private or public network elements, a virtual private network within the Internet, a wide area network, local area network, Voice over Internet Protocol network, or the like, or any combination thereof. The network 110 may be implemented using any appropriate transmission, switching and routing technologies, including but not limited to circuit-switched systems, Internet Protocol (IP), Asynchronous Transfer Mode (ATM) and Signaling System 7 (SS7).

In an embodiment, data links 125 connect network 120 to server 200. The server 200 connects to database 300. As described further herein, the server 200 manages storage and retrieval of information relating to contracts and agreements. In addition, the server 200 manages access to the database 300 by parties 110 such as borrowers, lenders, buyers, sellers and traders. Such parties may access the database 300 over data links 115 to network 120 using PCs 110A, 110B, 110C configured with appropriate browser (e.g., secure web portal) or other application software.

A secure web portal on the server 200 provides borrowers, lenders, buyers, sellers and traders with access to review their contracts, agreements and other transactions. Access to the information may be provided after a registration process to ensure that access is limited to appropriate information and that security is maintained to avoid any unauthorized access.

As will be appreciated, the server 200 and database 300 may reside on the premises of a bank or other financial institution, local administration facility, central administration facility, or other remote facility.

In general, it should be understood that the communication between and among the various parties 110 may be through an interactive web-based computer system, a client server system or a system using telephony or any other means of communication. Through such communication it is possible to indicate willingness to enter into contracts while facilitating the actual creation of contracts and the conducting of transactions along with the transferring of funds.

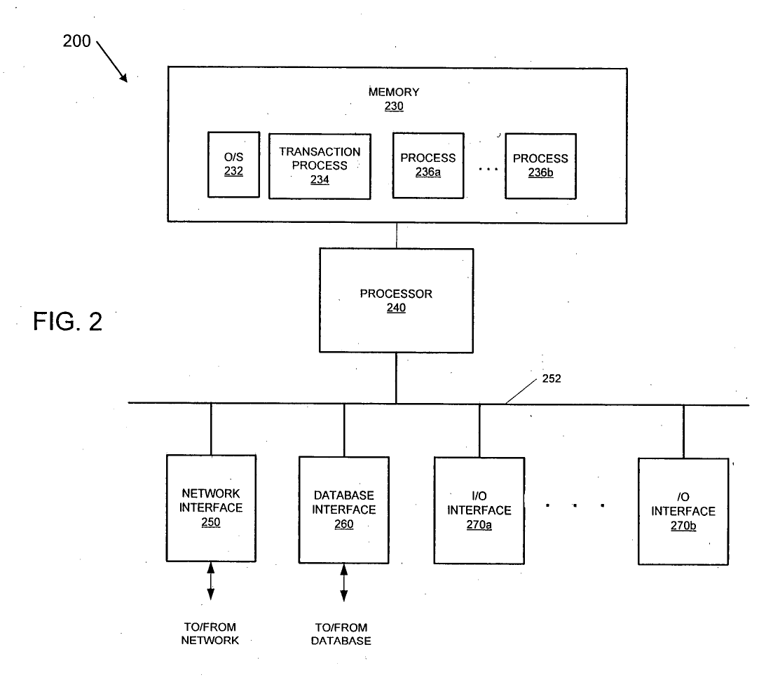

FIG. 2 is a high-level block diagram of an exemplary server 200 that may be used with the techniques described herein. Server 200 comprises a memory 230 that is coupled to a processor 240, a network interface 250, a database interface 260 and one or more I/O interfaces 270 via an I/O bus 252.

The network interface 250 is a conventional network interface comprising circuitry that provides an interface for the server 200 with the network 120 (FIG. 1) and enables information to be transferred between the server 200 and the network 120. To that end, network interface 250 incorporates signal, electrical and mechanical characteristics, and interchange circuits, needed to interface the server 200 with the physical media of the network 120 and protocols running over that media.

The database interface 260 is a conventional database interface comprising circuitry that provides an interface for the server 200 with the database 300 (FIG. 1) and enables information to be transferred between the server 200 and the database 300. To that end, database interface 260 incorporates signal, electrical and mechanical characteristics, and interchange circuits, needed to interface the server 200 with the database 300.

The processor 240 is a conventional CPU comprising processing circuitry configured, inter alia, to execute computer-executable instructions and manipulate data contained in memory 230. The I/O interfaces 270 comprise circuitry that interface various input and/or output devices (not shown) with the processor 240, such as, e.g., keyboards, display units and the like. The memory 230 is a computer-readable medium organized as a RAM that is implemented as memory devices which may be some combination of volatile and non-volatile devices, as described above. The memory is configured to hold computer-executable instructions and data structures including computer-executable instructions and data structures that implement aspects of the present invention.

The memory 230 illustratively contains an operating system 232, transaction process 234 and one or more processes 236. The operating system 232 is a conventional multi-tasking operating system configured to implement various conventional operating system functions which may include scheduling processes 234, 236 for execution, managing memory 230 and controlling access to devices coupled to the I/O interfaces 270. The transaction process 234 is a software process that contains computer-executable instructions and data to implement aspects of the techniques described further herein. The processes 236 are conventional software processes that contain computer-executable instructions and data that may implement other conventional aspects to support general processing as well as the supporting the techniques described herein.

Operationally, information (e.g., data packets containing contract information, attributes, etc.) that is generated by a PC 110A, 110B, 110C is forwarded onto the network 120. The server 200 receives the information (e.g., data packets) from the network 120 at its network interface 250 which forwards the information to the processor 240 for further processing. Processor 240 processes the information which may include generating responses, forwarding information onto the network 120 via network interface 250, checking authorization of users associated with the information and so on.

It should be noted that functions performed by the server 200, including functions that implement aspects of the techniques described herein, may be implemented in whole or in part using some combination of hardware and/or software. It should be further noted that computer-executable instructions and/or data that implement aspects of the techniques described herein may be stored in various computer-readable mediums, such as flash memories, removable disks, non-removable disks and the like. In addition, it should be noted that various electromagnetic signals such as wireless signals, electrical signals carried over a wire, optical signals carried over optical fiber and so on may be encoded to carry computer-executable instructions and/or data that implement aspects of the present invention on, e.g., a communication network.

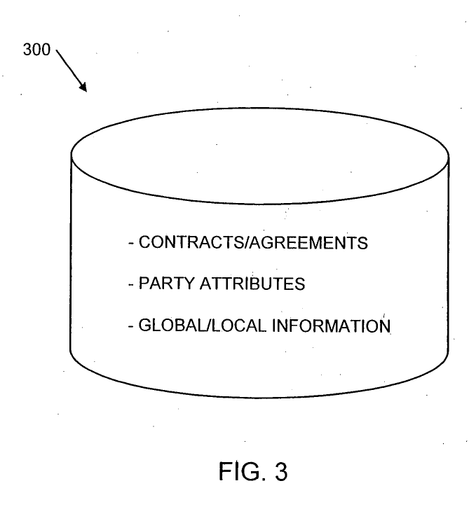

Referring now to FIG. 3, an example database 300 is shown. It should be understood that database 300 may comprise a number of databases. The database 300 stores information representing pending and potential financial contracts or agreements along with information about desires or willingness to be a party to such kinds of transactions or a party to some kind of partially or totally defined circumscribed transaction. The database also contains information that may be relevant to the transactions being conducted through ACS. This may include current and historical information related to the credit worthiness of the parties that may decide to enter into financial transactions through ACS. Global and local information relevant to the process may also be made available through the database 300 in a form that allows it to be useful to the computational processes that implement the ACS methodology.

An aspect of the ACS is the algorithmic contract (AC). The first principle of an AC is that it can be converted into the text of a legal and binding contract. As such, the printed version of an AC can include a signature page signed by the parties to the AC or some other equivalent. The parties involved receive the written signed documents while ACS can calculate with the algorithmic version of the contract. The AC itself can exist in many forms, one of which is as a computational algorithm that can be both interpreted and analyzed by various software applications. Regardless of the canonical form of the AC, it can be converted from one form to another. For example, a very useful form is tabular. This is a table of relevant information written out in a form similar to what one enters into a cell in a spreadsheet. Thus, a cell might have a number or a range of values might be specified by two cells, e.g., dates and amounts of money.

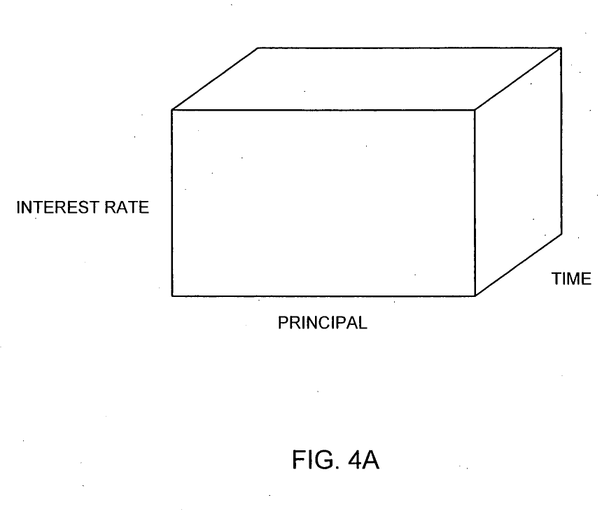

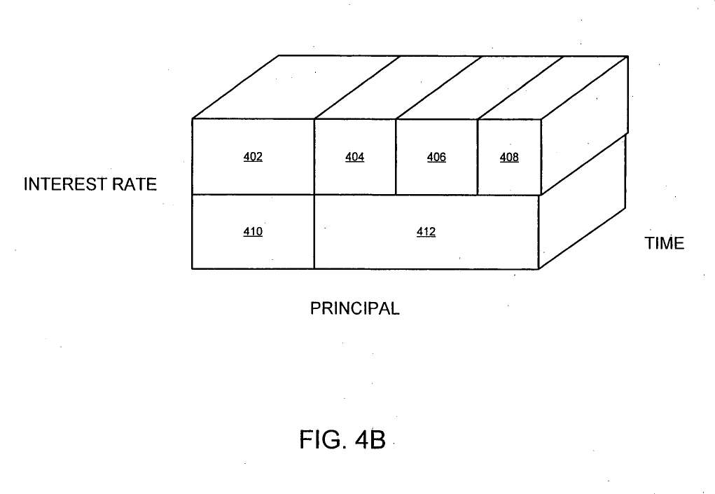

In an embodiment, each AC may correspond to a generalized “box”, where the volume of the box is equal to the cost (or profit) of the transaction. For a simple deposit, the amount of money (principal P) may correspond to the length of the box, the amount of time (T) the money is deposited may correspond to the width of the box and the interest rate (percentage I) may correspond to the height of the box. Thus, the volume of the box (length×width×height or P×T×I) is equal to the total amount of interest. This construct is illustrated in FIG. 4.

An AC can also be used as data by a software process within ACS, embodied as artificial intelligence software, for example. An AC may be translated into the form of HTML or XML where both the text and other features of such systems can come into play with respect to the software that analyzes and manipulates such representations and information stated or implied by such representations. What is unusual about the AC is that it is meant to embody a contract that is a commitment by one party, a contract between two or more parties or other contracts where the AC is definite in some or all respects but where the AC may also be much less definite. As an example, a bank may agree, for a period of 90 days from the date of the contract, to be willing to borrow (or receive as a deposit) $50 M starting on any day from one specified date to another. The interest it would be willing to pay may be specified as a percentage (e.g., “2.85%”) where the terms are defined such as “ . . . calculated over the term of the loan.” The term of the loan may be stated as “ . . . no less than 60 days and no more than 180 days.”There can be other terms some of which have numerical parameters while others may specify algorithms such as “ . . . London Interbank Offered Rate (LIBOR) plus 1%.”

Embodiments of the AC may be based on selecting transaction elements from a library of possible elements that can be part of a particular AC. New types of algorithmic constructs or new types of information may be added to the library. Thus, if a particular transaction requires a transaction element not in the library, the element is first added to the library.

The advantage of the AC is that ACS can, in a sense, understand each AC. ACS can calculate using an AC as data. It also can construct a new AC made up of a number of other AC's. In addition, it can calculate the values and costs of AC's and evaluate the risks associated with them.

One kind of transaction using ACS can be described by an example. A party wishes to borrow $100 M for a period of three years, starting within a 30 day period. Various other terms important to the borrower can be included. The borrower wishes to find a lender willing to meet the desired conditions, on terms most favorable to the borrower. Likely, it is possible to find within the database 300 (FIG. 1) attributes corresponding to a lender willing to enter into this transaction. But it is also possible that a much more complex solution would be more favorable to the borrower. Such possibly complex transactions can look perfectly simple to the borrower while the underpinnings of the transaction are very complex. ACS shields the borrower from the complexity while giving the borrower the financial advantage obtained.

There can be several stages in the existence of an AC. An AC can evolve from an existing algorithmic contemplated contract (ACC). An ACC states a serious desire to enter into an AC but is not binding on the offerer. An AC can evolve into an activated algorithmic contract (AAC). While an AC states a contractual willingness to perform a range of financial transactions, an AAC is a contract between two (or more) parties that involves the actual transfer of funds. The normal process is that ACS automatically finds ways to convert existing AC's into AAC's. Of course what is done automatically can and should be subject to review by knowledgeable and experienced persons. This kind of approval process can be handled through the same type of web based system (or other means of communication, including telephone, fax or other means) that is used by the others making use of ACS.

We can represent a class of financial transactions involving a borrower and a lender by a map. Each map is a geometric structure similar to a contour map. A map for a very simple financial transaction could be a solid rectangular box where the number of dollars is indicated by the horizontal width of the box, the time period by the length of the box and the interest by the height of the box, as noted above with reference to FIG. 4. The box is placed on a large surface graph where the date of the initiation of the contract (first transfer of funds) is determined by the y coordinate of the top of the box while the end of the contract (repayment of funds) is indicated by the y position of the bottom edge of the rectangle. The simplest solution to arranging for such a transaction is to find two congruent boxes, where the first one indicates the desires of the borrower and the second one indicates the willingness of the lender. If company A goes to a bank to borrow a sum of money there is one rectangle that represents the principal and interest of what A wants. If the bank agrees to lend the money, then what the bank is willing to do can be represented by a congruent box. Of course, a conventional bank may need to enter into other transactions in order to obtain the money that it agrees to lend.

Given that we have two congruent boxes, each representing an AC, we can convert this state of affairs into an AAC where the principal funds are transferred from the lender to the borrower. At some time in the future the completion of the AAC may involve the transfer of the principal funds from the borrower back to the lender. Of course, this is a very simple illustration as it ignores the more complicated terms typical of such transactions.

Transaction boxes do not have to be rectangular. For example, consider a $240 M, 20-year mortgage with repayment consisting of 240 monthly equal payments of principal, $1 M each, plus 6% interest. The box in this case can be a right triangular box $240 M wide at the top (one side of the triangle) and tapering down to $1 M wide at the bottom. The other side of the triangular box can be 240 months long. This triangular box has a height corresponding to the 6% interest term.

From the foregoing, it more generally is the case that ACS provides for creating the solution box for the contemplated transaction by finding many smaller diverse boxes from its database of willing lenders. While finding an optimal “tiling” of boxes to match a given box is a goal, it is not necessary as it may be sufficient to find a very good tiling that is more efficient than the normal processes taken by the existing banking system. Such an increase in efficiency means that both the borrower and the lender can obtain better results than is likely within the existing system of banking. The algorithmic nature of the AC makes it simpler to perform this tiling, as an AC can specify variables such as the amount of money or the time periods as algorithms (formulas or tables that can be presented by programs).

An aspect of the ACS is the ability to calculate ways to tile boxes representing desired transactions by other boxes. In other words, such parameters as the amount of money, the start date and the ending date are all possibly variables so that ACS can adjust (or fill in) the variables so as to arrange to make best use of the possibilities inherent in each AC that is use to completely tile another AC.

Our use of the term “box” is not limiting in ACS. By “tiling” we mean any constructions of larger transactions from a number of other transactions or any breakdown of larger transactions into a number of other transactions or single transactions into multiple transactions that satisfies conditions desired by all those involved in the transaction or in the set of transactions. Again the examples are not meant to be limiting. An AC has a manifold of allowable implementations (the fixing or limiting of parameters). There is likely no restriction on exploiting every possibility when engaged in putting together multiple transactions, over both amounts of funds and over intervals of time along with adjustments to other parameters or conditions to accomplish a desired transaction. The basis for finding efficient tilings may be embodied in software (which can use AI technologies when appropriate) that looks at a database that contains both AC's and ACC's and even AAC's. The database can also include information related to such transactions including those that change from time to time and including transient events or any other events that can affect aspects of financial transactions.

One key to understanding ACS is the fact that almost all AC's may have parameters that can be adjusted in creating a transaction. For example, a bank, desirous of receiving deposits, may issue an AC stating a minimum deposit size, a maximum total of deposits, an interest rate keyed to some standard rate, a defined period of time during which this AC would be active, other parameters concerning the period of time that a deposit would have to remain in the bank in order to be paid that interest rate, etc.

In addition to fulfilling a particular box by tiling the volume with many other boxes, it is also possible that one set of boxes is effectively tiled by another set of boxes.

We will now describe in more detail how the transaction tiling may be done. Assume that a depositor wants to deposit $100 M starting on StartDate and wants to withdraw the funds on EndDate. The depositor enters into an AC with ACS. The AC may specify the degree of security that the depositor wants or it may specify the rate of interest or both or neither. It is up to the ACS to find the best results for the depositor. To do this the ACS looks at entries in its database. It can reduce the number by eliminating entries that have a simple totally incompatible condition that rules out any possible contribution. However, many seeming incompatibilities can be resolved by involving concepts such as insurance or additional depositors in the same group of related transactions. The simplest case may involve finding a single AC from a borrower whose parameters can be adjusted to match the depositor's AC. However, in most cases ACS finds more favorable solutions by picking a large set of seemingly incompatible AC's and finding a complex of them to fulfill the depositor's requirements. This may generate additional needs for other depositors as some of the boxes used to cover the current depositor's AC may be too large. ACS may then search for additional depositors in the AC database. This process continues, in a sense roaming around the solution space, as the ACS works to find combinations of transactions that optimize the results for all parties.

FIG. 4B illustrates an example of the tiling based on covering a client box with multiple candidate transactions. In particular, the candidates include boxes 402-412 of varying size.

ACS can easily operate worldwide with transactions involving multiple currencies. For example, it may be that the best return for a depositor can be obtained in the Euro market. Of course, it may be necessary to hedge the transaction against the Euro falling vs. the Dollar, but the transaction, including the hedge, may still be the most favorable for the depositor. The point is that complexity that may be too great for human bankers to deal with is not a problem for ACS. In fact ACS can always take into account many kinds of subtlety that might escape human bankers. For example, risks in the financial world can be intricately interconnected. One bank may have no funds lent to a corporation in financial trouble while they are nevertheless heavily connected to other banks that are more directly at risk. A foreign insurer of loans might be over exposed due to correlations it is unaware of. ACS can keep better track of every available piece of information and make use of facts that can be concluded from that information in evaluating the quality of banks, corporate borrowers, governments and insurers. Instead of simple “Go-No Go” decisions, such factors can be considered and brought into the overall evaluation and the overall methodology of constructing sets of financial transactions out of other sets of financial transactions.

Another aspect of ACS is that it can bring the concept introduced by Junk Bonds to fruition as an extension of normal deposits and loans. The reason is that ACS can be in a better position to quantify risks and to calculate equitable interest rates for risky loans. It can also seek or offer insurance for such loans so as to make them competitive, to the lenders, with those placed with more secure borrowers.

ACS can implement new technologies for compliance by observing what is happening with its clients. A condition of doing a transaction with ACS can be a specified level of transparency where the borrower or bank receiving funds agrees to make pertinent information available directly to the ACS system. Of course, this would need to be monitored by experienced financial analysts. The point is that ACS can base proposed solutions on information that is current, e.g., no more than a few minutes old.

In an embodiment, given a new AC (which may arrive via a web-based system from an ACS client), one part of ACS checks it over to make sure it is complete. It may interact with the sender to see that the AC is complete. The client would have used the web portal to compose the AC and to print out an English Language version in conventional contract language. The client then may sign the paper copy and send it to ACS by express mail. The tracking number for the signed copy may be part of the information that the client enters into the web based portal. Upon receipt of the AC, ACS may enter it into its database. This starts the process of finding complementary AC's in the database that can be used to find various solutions. In the case where the desired date for the initiation of the transaction is still off in the future (say 30 days out) then ACS may save the solutions it found. As new information enters the database, the client's proposed transaction is revisited and reviewed, looking for better solutions. If a particularly good one is found prior to the date of initiation, ACS can contact the client and offer to let the client fix the deal. The client could accept those terms or wait to see if better terms come up.

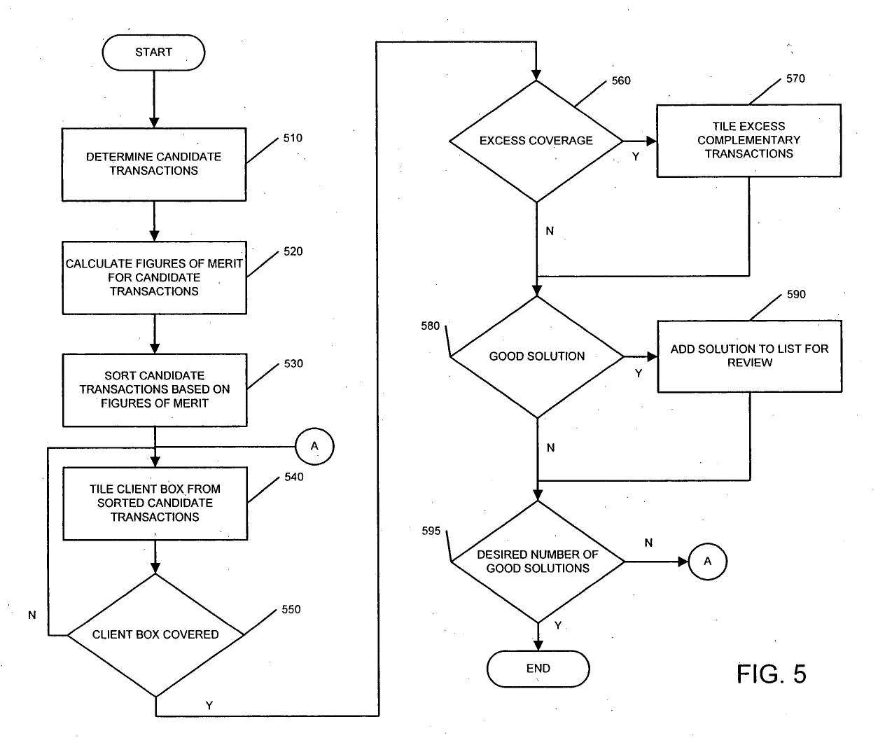

A process for defining one or more solutions for a proposed transaction received from a client 110 (FIG. 1) is illustrated in FIG. 5. At the start, the ACS server 200 (FIG. 2) at 510 determines candidate transactions (AC's) that might be used to satisfy the proposed transaction. This may include both complementary transactions and similar transactions. At 520, the server calculates a number of figures of merit regarding the attractiveness of the various candidate transactions with respect to the particular client. For example, one figure of merit may relate to interest rate, another may relate to the size of principal available, another may be repayment terms, etc. Other criteria for calculating figures of merit may be contemplated based on the nature of the transaction and the parties.

At 530, the server sorts the list of candidate transactions, for each figure of merit, according to that figure of merit. At 540, the server attempts to tile the client box, representing the proposed transaction, with other boxes drawn from the various sorted lists. At 550, the server checks whether the client's box is covered. If not, then the tiling process continues at 540. If the client's box is covered, then a check is made at 560 to determine whether excess coverage exists, that is, greater than 100% coverage of the client's box. If yes, then at 570 the excess is tiled based on complementary transactions, i.e., transactions with other parties to cover the excess amounts that are outside the client's box.

Processing continues at 580 with the server determining whether the candidate solution is a “good” solution relative to criteria for judging the overall solution in relation to the client and other parties to the candidate solution. If the candidate solution is deemed good, then at 590 it is added to a list of candidate solutions for review by the client and other interested parties to the proposed transaction. Processing continues at 595 with a check to see if a desired number of candidate solutions has been found. If not, then processing continues through additional repetitions of the loop from 540 so as to explore the space of possible solutions. Otherwise, the process ends.

The number of “good” solutions may be based on finding them in a reasonable amount of time. “Reasonable” may be calculated in the context of the size of the transaction. For example, a $1 B transaction is worth doing a lot more optimization than is a $100 K transaction. It is quite possible that the best solutions may involve hundreds of transactions.

If an exact solution is found (which should almost always be the case) then this solution may be set aside for subsequent review and final activation (on the date specified by the client) along with all the component transactions. If an approximate solution is found that cannot be made exact, the client may be contacted or wait, if allowable, and try the process later.

It will be apparent to those of ordinary skill in the art that methods involved in the present invention may be embodied in a computer program product that includes a computer usable medium. For example, such a computer usable medium may consist of a read only memory device, such as a CD ROM disk or conventional ROM devices, or a random access memory, such as a hard drive device or a computer diskette, having a computer readable program code stored thereon.

While this invention has been particularly shown and described with references to example embodiments thereof, it will be understood by those skilled in the art that various changes in form and details may be made therein without departing from the scope of the invention encompassed by the appended claims.

What is claimed is:

1. A method comprising:
receiving a request for a financial transaction having transaction parameters;
selecting candidate transactions based on one or more of the transaction parameters; and
combining the selected candidate transactions to provide a transaction solution.

2. The method of claim 1 wherein selecting comprises:
calculating one or more figures of merit for the candidate transactions;
sorting the candidate transactions based on the figures of merit.

3. The method of claim 1 wherein combining comprises:
representing the requested transaction as a three-dimensional object;
representing the selected candidates as three-dimensional objects;
tiling the three-dimensional object representing the requested object with the three-dimensional objects representing the selected candidates.

4. The method of claim 1 further comprising repeating the selecting and the combining to provide multiple transaction solutions.

5. The method of claim 1 further comprising sending the transaction solution to a party to the requested transaction.

6. The method of claim 1 wherein the transaction parameters include interest rate, amount of principal, time duration of term, start date of requested transaction and end date of requested transaction.

7. The method of claim 1 wherein the request is received from a borrower and the candidate transactions include multiple lenders.

8. The method of claim 1 wherein the request is received from a lender and the candidate transactions include multiple borrowers.

9. The method of claim 1 wherein the request is received from a buyer and the candidate transactions include multiple sellers.

10. The method of claim 1 wherein the request is received from a seller and the candidate transactions include multiple buyers.

11. A system comprising:
a transaction database;
a server configured to receive a request for a financial transaction having transaction parameters, select candidate transactions from the transaction database based on one or more of the transaction parameters and combine the selected candidate transactions to provide a transaction solution.

12. The system of claim 11 wherein the server is configured to select candidate transactions by calculating one or more figures of merit for the candidate transactions and sorting the candidate transactions based on the figures of merit.

13. The system of claim 11 wherein the server is configured to combine selected candidate transactions by representing the requested transaction as a three-dimensional object, representing the selected candidates as three-dimensional objects and tiling the three-dimensional object representing the requested object with the three-dimensional objects representing the selected candidates.

14. The system of claim 11 wherein the server is further configured to send the transaction solution to a party to the requested transaction.

15. The system of claim 11 wherein the transaction parameters include interest rate, amount of principal, time duration of term, start date of requested transaction and end date of requested transaction.

16. The system of claim 11 wherein the request is received from a borrower and the candidate transactions include multiple lenders.

17. The system of claim 11 wherein the request is received from a lender and the candidate transactions include multiple borrowers.

18. The system of claim 11 wherein the request is received from a buyer and the candidate transactions include multiple sellers.

19. The system of claim 11 wherein the request is received from a seller and the candidate transactions include multiple buyers.

20. A system comprising:
means for receiving a request for a financial transaction having transaction parameters;
means for calculating one or more figures of merit for the candidate transactions;
means for sorting the candidate transactions based on the figures of merit;
means for representing the requested transaction as a three-dimensional object;
means for representing the selected candidates as three-dimensional objects;
means for tiling the three-dimensional object representing the requested object with the three-dimensional objects representing the selected candidates to provide a transaction solution.
